(19) United States
(12) Patent Application Publication
(10) Pub. No.: US 2026/0192719 A1
(43) Pub. Date: Jul. 9, 2026

(54) SEAT

(71) Applicant: DELTA KOGYO CO., LTD., Hiroshima (JP)

(72) Inventors: Kohei ISODA, Hiroshima (JP); Masahiro HIRANO, Hiroshima (JP)

(73) Assignee: DELTA KOGYO CO., LTD., Hiroshima (JP)

(21) Appl. No.: 18/863,810

(22) PCT Filed: Apr. 5, 2023
(86) PCT No.: PCT/JP2023/014029

§ 371 Date: Nov. 7, 2024

(30) Foreign Application Priority Data
May 12, 2022 (JP) 2022-078779

(51) Int. Cl. B60N 2/58; B68G 7/052; B68G 7/12

(52) U.S. Cl. CPC B60N 2/5825; B68G 7/052; B68G 7/12

(57) ABSTRACT

A seat includes a cushion pad, a trim, and a resin clip. The resin clip has a base, a trim fixing part, a curving part, a first barb part, a second barb part, and a third barb part. The curving part has flexibility and is in a groove section of the cushion pad together with the base. Each of the base and the curving part in the groove section is pressed with a pressing force in such a manner that the other end being a free end of the curving part is closer to the base. In the groove section, the first barb part has a leading end pushed in the cushion pad from a first side wall. Each of the second barb part and the third barb part has a leading end pushed in the cushion pad from a second side wall with a reaction force against the pressing force.

### TECHNICAL FIELD

The present invention relates to a seat, in particular, relates to a structure of fixing a trim to a cushion pad.

### BACKGROUND ART

A seat, such as an automobile seat, adopts a structure including a seat cushion for supporting the buttocks of an occupant, a seatback for supporting the back of the occupant, a cushion pad made of resin material or other material in each of the seat cushion and the seat back, and a trim made of leather, vinyl leather, or other material and covering the cushion pad. The trim is fixed to the cushion pad on a rear surface of the cushion pad (i.e., a surface that is opposite to the surface with which the buttocks or the back comes into contact).

Patent Literature 1 discloses a structure of fixing a trim through preparation of a plurality of fixing groove sections on a rear surface of a cushion pad and insertion of a plurality of resin clips respectively in the groove sections. Each resin clip in the structure of Patent Literature 1 has: a trim fixing part holding an end of the trim; a base having a plate shape and being in the associated groove section of the cushion pad; and a pressing part having flexibility and extending from a lower end (an end inserted in the groove section) of the base to an opening of the groove section, the trim fixing part, the base, and the pressing part being integrally formed. In the state where the base and the pressing part of the resin clip are in the groove section, the pressing part applies a pressing force outward (outward in a cross-sectional direction of the groove section) to a side wall of the groove section. The structure disclosed in Patent Literature 1 enables attachment and detachment of the trim to and from the cushion pad with high workability.

In the structure disclosed in Patent Literature 1, the resin clip in the groove section of the cushion pad is always under tension in a fixing direction of the trim (a cross-sectional direction of the groove section) to the trim fixing part. Further, the resin clip may have heat in some circumstances. For instance, the resin clip may have heat in a case where a relevant seat is arranged indoors and receives direct sunlight, or the resin clip may have heat in a case where the seat is arranged in a vehicle and a temperature in the vehicle increases.

When the resin clip has such heat as aforementioned, the resin clip made of resin material has a tendency to plastically deform due to the heat. From this perspective, the resin clip may come off the groove section of the cushion pad. If the resin clip comes off the groove section of the cushion pad, a part of the trim will be detached from the cushion pad in conjunction with the coming-off of the resin clip.

### Citation List

### Patent Literature

Patent Literature 1: Japanese Unexamined Patent Publication No. 2022-26060

### Summary of Invention

The present invention has been accomplished in view of the aforementioned disadvantages, and has an object to provide a seat that allows a trim to maintain a state of being stably fixed to a cushion pad while preventing a resin clip from coming off the cushion pad even when the resin clip has heat.

A seat according to one aspect of the present invention includes a cushion pad, a trim, and a resin clip. The cushion pad has a support region for supporting an occupant, and other region excluding the support region and having a groove section in a thickness direction. The trim has a covering region that covers the support region of the cushion pad, and an end being adjacent to the groove section. The resin clip is made of resin material, holds the end of the trim, and is configured to fix the trim and the cushion pad to each other through the groove section.

In the seat according to the aspect, the resin clip has a base, a trim fixing part, a curving part, a first barb part, a second barb part, and a third barb part. The base is in the groove section of the cushion pad. The trim fixing part is continuous to a portion at an upper end of the base, extends from the continuous portion along a surface of the cushion pad in a first direction being in a width direction of the groove section, and fixes the end of the trim thereto. The curving part has one end being continuous to the base and other end being a free end, has a curve shape to be farther away from the base in the first direction as advancing from the one end toward the other end, is in the groove section together with the base while extending along the base, and has flexibility.

The first barb part is continuous to a portion of the curving part between the one end and the other end, extends from the continuous portion in the first direction, and has a leading end which tapers. The second barb part is continuous to a portion of the base, extends from the continuous portion in a second direction opposite to the first direction being in the width direction of the groove section, and has a leading end which tapers. The third barb part is continuous to a portion of the base between the continuous portion to the second barb part and the continuous portion to the trim fixing part, extends from the portion in the second direction, and has a leading end which tapers.

In the seat according to the aspect, each of the base and the curving part of the resin clip is pressed with a pressing force in such a manner that the other end is closer to the base in a state where the base and the curving part are in the groove section than in a free state where the base and the curving part are outside the groove section.

In the seat according to the aspect, in the groove section of the cushion pad, the leading end of the first barb part is pushed in the cushion pad from a first side wall being a side wall of the groove section in the first direction with a reaction force against the pressing force. The leading end of the second barb part and the leading end of the third barb part are pushed in the cushion pad from a second side wall being a side wall of the groove section in the second direction with a reaction force against the pressing force.

### BRIEF DESCRIPTION OF DRAWINGS

FIG. 1 is a exploded view of a configuration of a seat according to an embodiment.

FIG. 2 is a perspective view of a configuration concerning a lower surface of a cushion pad.

FIG. 3 is an enlarged perspective view of a groove section in the cushion pad.

FIG. 4 is a cross-sectional view of a configuration of the cushion pad and a structure of fixing a trim to the cushion pad.

FIG. 5 is an enlarged cross-sectional view of a portion A in FIG. 4 illustrated in an enlarged manner.

FIG. 6 is a perspective view of a configuration of a resin clip.

FIG. 7 is a cross-sectional view of the resin clip attached to the groove section of the cushion pad.

FIG. 8 is an illustration for explaining a role of a flat section of a barb part of the resin clip in cross-section.

FIG. 9 is an illustration for explaining a procedure of detaching the resin clip from the groove section of the cushion pad in cross-section.

### DESCRIPTION OF EMBODIMENTS

Hereinafter, an embodiment of the present invention will be described with reference to the accompanying drawings. It is noted that the following embodiment illustrates one example of the present invention, and the present invention is not delimited to the embodiment except its essential configuration.

### Embodiment

### 1. Brief Configuration of a Seat 1

The seat 1 according to the embodiment represents an example vehicle seat for an automobile as a rear seat.

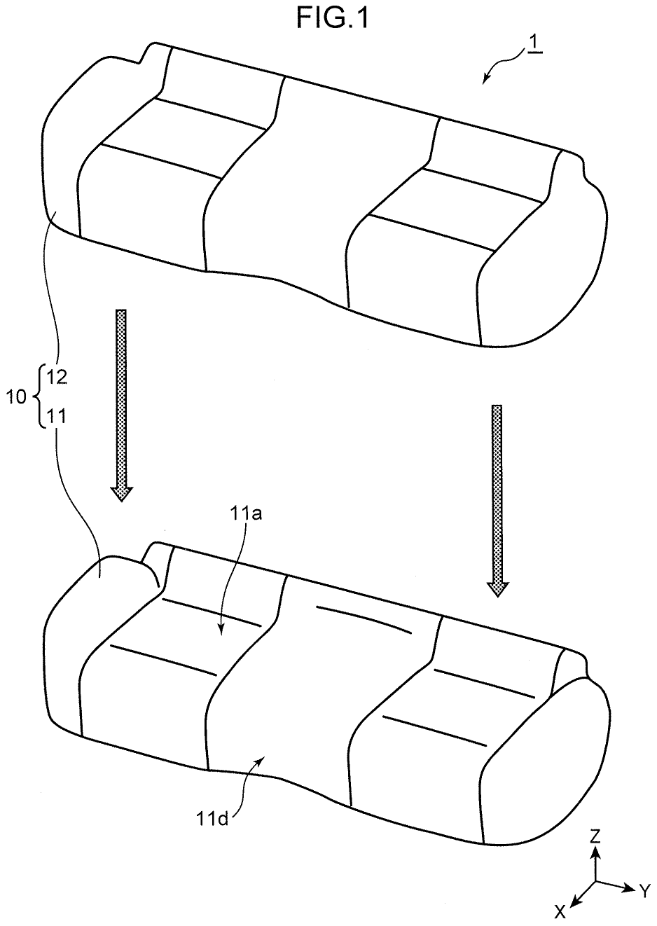

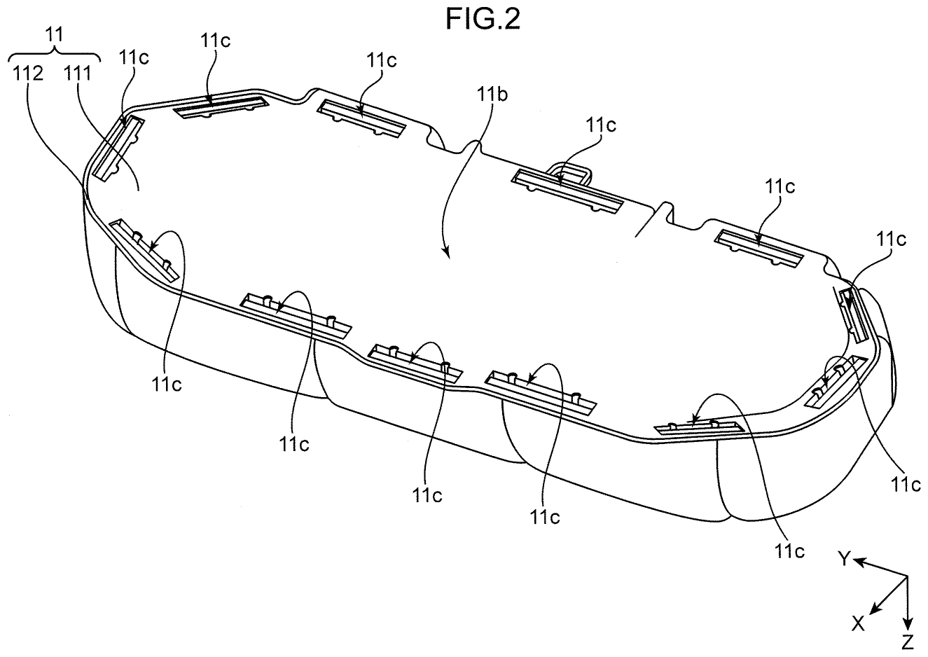

A configuration of the seat 1 will be briefly described with reference to FIG. 1 and FIG. 2. Each drawing accompanied by the present specification illustrates only a seat cushion 10 in the configuration of the seat 1 without illustration of a seatback.

As illustrated in FIG. 1, the seat cushion 10 of the seat 1 includes a cushion pad 11 and a trim 12. The cushion pad 11 is configured to support the buttocks of an occupant on an upper surface 11a thereof. The upper surface 11a of the cushion pad 11 corresponds to the “support region” and the remaining region corresponds to “other region”.

As illustrated in FIG. 2, the cushion pad 11 includes a hard pad 111 and a soft pad 112 stacked one on another. The hard pad 111 is relatively harder than the soft pad 112. The soft pad 112 is stacked on the hard pad 111 to extend over a surface thereof at the upper surface 11a and a front surface 11d of the cushion pad 11. The hard pad 111 is exposed outside on a lower surface 11b of the cushion pad 11.

In the embodiment, the hard pad 111 is made of beads foam, such as expanded polystyrene (EPS), and has shape retention. The soft pad 112 is made of urethane foam resin and has resilience.

As illustrated in FIG. 1, the trim 12 is configured to cover at least the upper surface 11a and the front surface 11d of the cushion pad 11. In the embodiment, a region of the trim 12 covering the upper surface 11a and the front surface 11d of the cushion pad 11 corresponds to the “covering region”. For example, the trim 12 is made of sheet-shaped material, such as leather or vinyl leather.

As illustrated in FIG. 2, in a plan view of the cushion pad 11 from the lower surface 11b, the hard pad 111 is exposed outside on the lower surface 11b of the cushion pad 11 except an edge portion. A plurality of groove sections 11c is provided along an outer edge of the hard pad 111. Each of the groove sections 11c has an elongated rectangular opening.

### 2. Configuration of Each Groove Section 11c and a Periphery of the Groove Section 11c

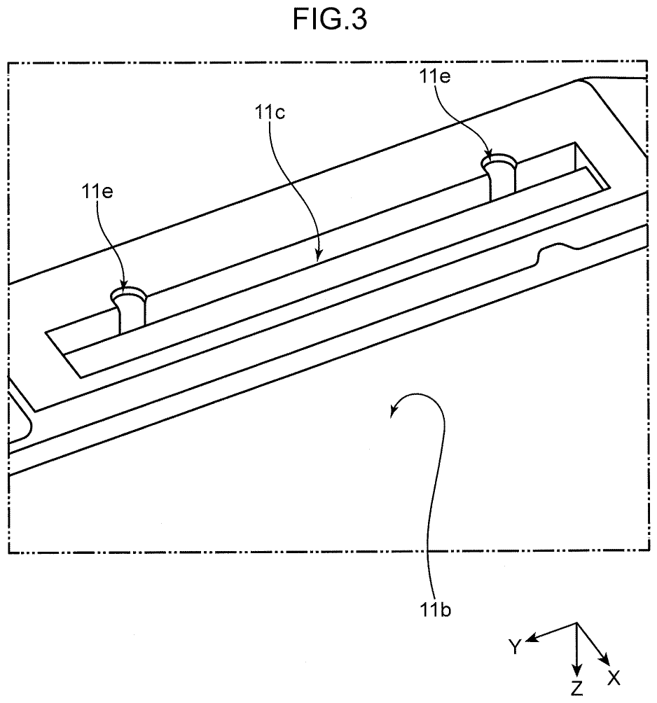

The configuration of each groove section 11c and the periphery of the groove section 11c will be described with reference to FIG. 3. FIG. 3 illustrates one of the groove sections 11c at the lower surface 11b of the cushion pad 11. The remaining groove sections 11c have the same configuration. A directional relation among an X-direction, a Y-direction, and a direction of the groove section 11c in FIG. 3 changes depending on a location of the groove section 11c.

As illustrated in FIG. 3, the groove section 11c has an opening in a rectangular shape which is long in the Y-direction, and is recessed in a Z-direction (toward the upper surface 11a) from the lower surface 11b of the cushion pad 11.

The cushion pad 11 has two communicating passages 11e adjoining the groove section 11c in a longitudinal direction (Y-direction) of the groove section 11c. Each communicating passage 11e is located opposite the edge portion of the lower surface 11b of the cushion pad 11, and has an opening in a semicircular shape.

The two communicating passages 11e are apart from each other in the longitudinal direction (Y-direction) of the groove section 11c. Each communicating passage 11e has substantially the same depth as the groove section 11c to communicate with the groove section 11c in a whole region thereof in the depth direction.

The purpose of the communicating passages 11e will be described later.

### 3. Structure of Fixing the Trim 12 to the Cushion Pad 11

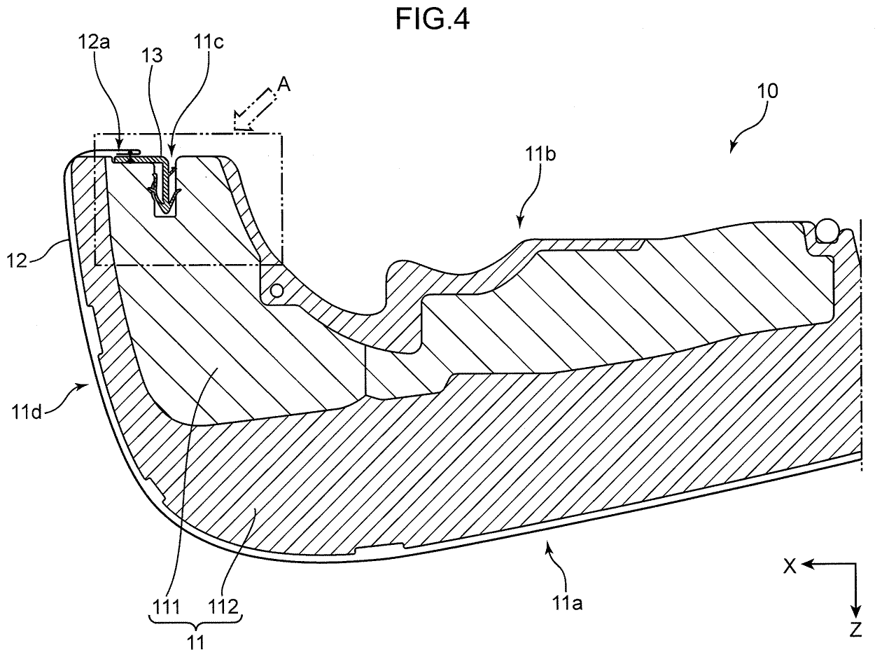

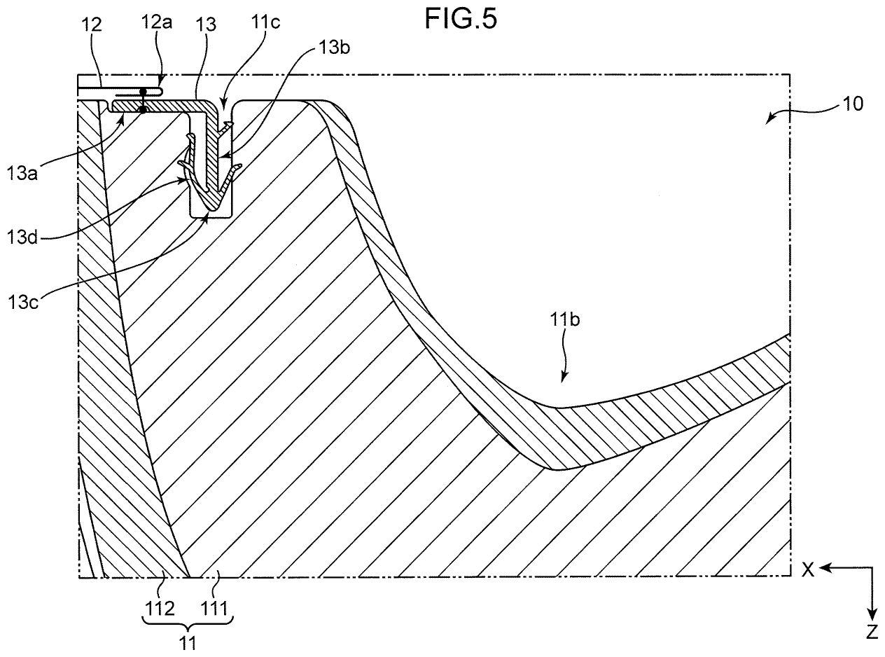

The structure of fixing the trim 12 to the cushion pad 11 in the seat cushion 10 will be described with reference to FIG. 4 and FIG. 5. FIG. 5 is an enlarged cross-sectional view of the portion A in FIG. 4 illustrated in an enlarged manner.

As illustrated in FIG. 4 and FIG. 5, on the lower surface 11b of the cushion pad 11, the hard pad 111 is exposed outside at the edge portion of the lower surface 11b. The trim 12 is arranged to cover a region from the upper surface 11a to the edge portion of the lower surface 11b of the cushion pad 11. The trim 12 has an end 12a located on the lower surface 11b of the cushion pad 11 and held by a resin clip 13. The seat 1 is provided with the same number of resin clips 13 as the number of groove sections 11c in the cushion pad 11.

As illustrated in FIG. 5, each resin clip 13 is made of, for example, polypropylene, and has a trim fixing part 13a, a base 13b, and a curving part 13d, which are integrally and continuously formed. The trim fixing part 13a holds the end 12a of the trim 12 and extends along the lower surface 11b of the cushion pad 11 toward an edge of the cushion pad 11.

The base 13b has an upper end located in the Z-direction and leading to a right end of the trim fixing part 13a in the X-direction, extends in the Z-direction, and is in the groove section 11c. The base 13b has such a length in the Z-direction that a bottom end 13c is adjacent to a bottom of the groove section 11c.

The curving part 13d is continuous with the bottom end 13c of the base 13b and has a cross-sectional shape curving in an arc toward the opening of the groove section 11c. The curving part 13d is spaced leftward from the base 13b in the X-direction except a continuous portion to the base 13b. The curving part 13d is provided flexibly based on the continuous portion with the base part 13b.

In FIG. 4 and FIG. 5, a left in the X-direction agrees with the “first direction”, a right in the X-direction agrees with the “second direction”, the Z-direction agrees with the “third direction”, and a direction (a longitudinal direction of the groove section 11c) perpendicularly intersecting each paper agrees with the “fourth direction”.

### 4. Details of the Structure of the Resin Clip 13

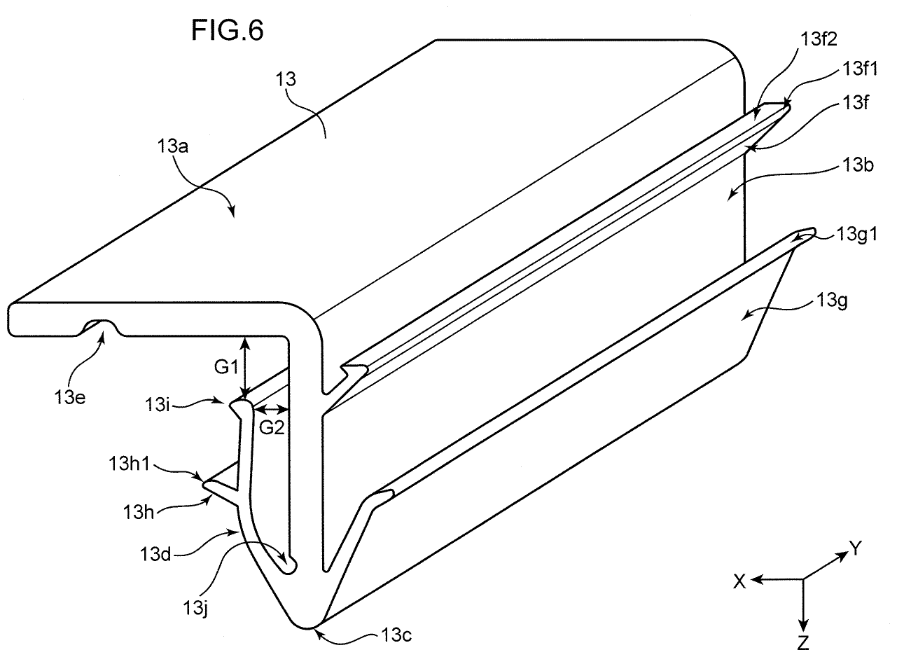

The structure of the resin clip 13 will be described in detail with reference to FIG. 6. FIG. 6 illustrates one of the resin clips 13. A directional relation among the X-direction, the Y-direction, and the direction of the resin clip 13 in FIG. 6 changes depending on the location of the resin clip 13.

As illustrated in FIG. 6, the resin clip 13 has such a long shape that a dimension in the Y-direction is longer than a dimension in each of the X-direction and the Z-direction in association with the dimension of the groove section 11c for insertion therein. The dimension of the resin clip 13 in the Y-direction is set to, for example, 50 mm to 150 mm. The dimension of the resin clip 13 in the X-direction is set to, for example, 15 mm to 25 mm. The dimension of the resin clip 13 in the Z-direction is set to, for example, 15 mm to 25 mm.

As described above, the curving part 13d is continuous to the base 13b from a portion at the bottom end 13c of the base 13b, extends from the continuous portion to a leading end 13i located upward in the Z-direction while curving in an arc. The continuous portion of the curving part 13d to the base 13b corresponds to the “one end”, and the leading end 13i corresponds to the “other end”.

The continuation portion between the curving part 13d and the base 13b has a depression 13j. The depression 13j is depressed toward the bottom end 13c from a meeting point between a left outer surface of the base 13b in the X-direction and a right outer surface of the curving part 13d in the X-direction. The depression 13j in this form is aimed at allowing the curving part 13d to be flexible at the connection portion between the base 13b and the curving part 13d as a reference.

The leading end 13i of the curving part 13d is a free end at a gap GI from a lower outer surface of the trim fixing part 13a in the Z-direction and at a gap G2 from a left outer surface of the base 13b in the X-direction.

The curving part 13d has a thickness which is smaller than a thickness of the base 13b. The smaller thickness of the curving part 13d than the thickness of the base 13b allows the curving part 13d to flex with a reaction force from a side wall of the groove section 11c while keeping the base 13b from flexing in insertion of the base 13b and the curving part 13d in the groove section 11c. In the embodiment, the thickness of the base 13b ranges from 1.0 mm to 4.0 mm, and the thickness of the curving part 13d ranges from 1.0 mm to 2.5 mm to be smaller than the thickness of the base 13b.

The resin clip 13 further has a recess 13e, a barb part (or a third barb part) 13f, a barb part (or a second barb part) 13g, and a barb part (or a first barb part) 13h. The recess 13e is recessed upward in the Z-direction from the lower outer surface of the trim fixing part 13a in the Z-direction to fix the trim 12.

The barb part 13h is continuous to a portion of the curving part 13d between the continuous portion to the base 13b and the continuous portion to the leading end 13i, and extends toward upper left. The continuous portion between the curving part 13d and the barb part 13h is at a leftmost position in the X-direction in the curving part 13d and in substantially the middle between the continuous portion to the base 13b and the leading end 13i in the Z-direction. The barb part 13h has a leading end 13h1 which tapers to face upper left (face the lower surface 11b of the cushion pad 11).

The barb part 13g extends rightward in the X-direction (opposite to the direction in which the curving part 13d extends) from the portion of the base 13b being adjacent to the bottom end 13c thereof and upward in the Z-direction. The barb part 13g has a leading end 13g1 which tapers to face upper right (face the lower surface 11b of the cushion pad 11). In the Z-direction, the leading end 13h1 of the barb part 13h and the leading end 13g1 of the barb part 13g are substantially at the same height position.

The barb part 13f is continuous to the base 13b slightly below the continuous portion of the base 13b to the trim fixing part 13a. The barb part 13f extends rightward in the X-direction (opposite to the direction in which the curving part 13d extends) and upward in the Z-direction in the same manner as the barb part 13g. The barb part 13f has a leading end 13f1 which tapers to face upper right (face the lower surface 11b of the cushion pad 11). The barb part 13f has a flat section 13f2 that is adjacent to the leading end 13f1 and extends in a direction perpendicularly intersecting the Z-direction. The flat section 13f2 extends in a direction substantially perpendicularly intersecting a right outer surface of the base 13b in the X-direction.

### 5. Configuration of Attaching the Resin Clip 13 to the Groove Section 11c of the Cushion Pad 11

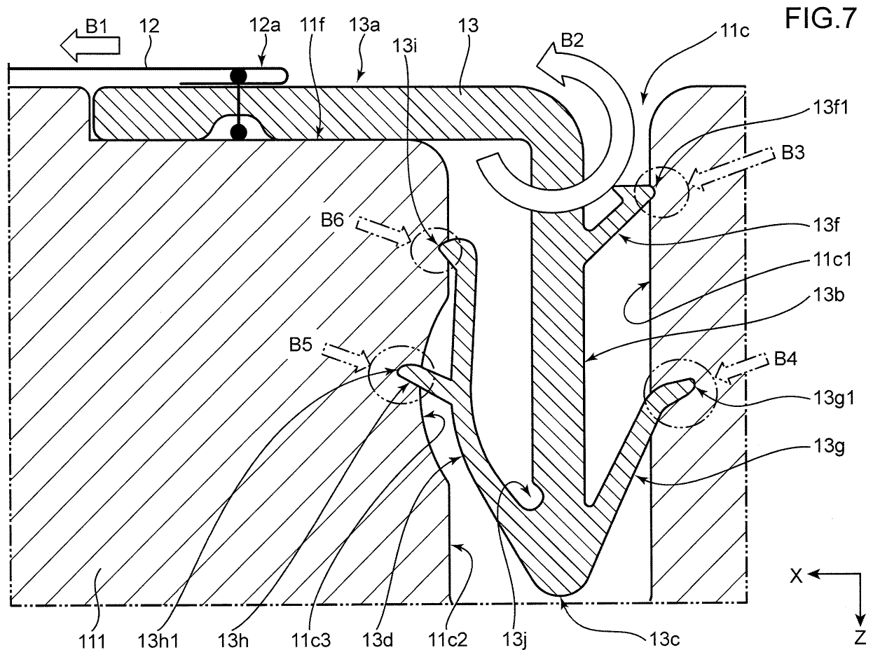

The configuration of attaching the resin clip 13 to the groove section 11c of the cushion pad 11 will be described with reference to FIG. 7. FIG. 7 illustrates one of the combinations of the groove sections 11c and the resin clips 13. A directional relation among the X-direction, the Y-direction, and the direction of each of the groove section 11c and the resin clip 13 changes depending on the locations thereof.

As illustrated in FIG. 7, in the seat cushion 10, the base 13b and the curving part 13d of the resin clip 13 are in the groove section 11c of the cushion pad 11 in the state where the trim fixing part 13a holds the end 12a of the trim 12. The lower surface 11b of the cushion pad 11 has a recess 11f leading to the left of the groove section 11c in the X-direction. The recess 11f has a depth in the Z-direction that substantially corresponds to a thickness of the trim fixing part 13a of the resin clip 13. Thus, the trim fixing part 13a is defined to fit in the recess 11f in the state where the base 13b and the curving part 13d of the resin clip 13 are in the groove section 11c.

The bottom end 13c of the base 13b being in the groove section 11c is adjacent to a groove bottom of the groove section 11c. The base 13b is in a posture that both the outer surfaces thereof in the X-direction are away from opposite side walls 11c1, 11c2 of the groove section 11c respectively.

Here, each of the base 13b and the curving part 13d is pressed with a pressing force in such a manner that the leading end 13i of the curving part 13d is closer to the base 13b in a width direction (X-direction) of the groove section in the state where the base 13b and the curving part 13d are in the groove section 11c than in a free state where the resin clip 13 is outside the groove section 11c. Besides, in the groove section 11c, each of the base 13b and the curving part 13d always applies a reaction force in the X-direction against the pressing force.

The curving part 13d is in a posture at a distance from the left side wall 11c2 of the groove section 11c in the X-direction at a cavity 11c3 around the middle of the side wall 11c2 in the Z-direction and below the cavity 11c3. The curving part 13d has the leading end 13i facing the side wall 11c2 (facing in the first direction), and tapers from a vicinity of the leading end 13i toward the leading end 13i. The leading end 13i of the curving part 13d is slightly pushed (stuck) in the hard pad 111 above the cavity 11c3 of the side wall 11c2 (arrow B6).

The barb part 13h is in a state with the leading end 13h1 pushed (stuck) in the hard pad 111 from the cavity 11c3 of the side wall 11c2 (arrow B5). The leading end 13h1 of the barb part 13h is pushed leftward in the X-direction with the reaction force and maintains the state of being firmly stuck in the hard pad 111.

The barb part 13g is in a state with the leading end 13g1 pushed (stuck) in the hard pad 111 from the side wall 11cl (arrow B4). The leading end 13g1 of the barb part 13g is pushed rightward in the X-direction with the reaction force and maintains the state of being firmly stuck in the hard pad 111.

The barb part 13f is in a state with the leading end 13f1 pushed (stuck) in the hard pad 111 from the side wall 11cl (arrow B3). In this regard, the leading end 13f1 of the barb part 13f is stuck in the hard pad 111 while a part of the flat section 13f2 remains in the groove section 11c without being pushed in the hard pad 111.

Here, the trim 12 is fixed to the cushion pad 11 under tension without a crease on the upper surface 11a or the front surface 11d of the cushion pad 11. Hence, the resin clip 13 holding the trim 12 is always under the tension as denoted by the arrow B1. The resin clip 13 always being under the tension denoted by the arrow B1 receives a rotation moment aimed at moving the bottom end 13c of the base 13b toward the right side wall 11c1 in the X-direction (arrow B2).

A resin clip without a barb part would plastically deform due to heat applied thereto in the rotation moment and then come off the groove section 11c.

In contrast, in the seat 1 according to the embodiment, the resin clip 13 has the three barb parts 13f to 13h at the aforementioned locations, and the respective leading ends 13f1, 13g1, 13h1 of the barb parts 13f to 13h are stuck in the hard pad 111. This prevents the resin clip 13 even having the heat from coming off the groove section 11c.

### 6. Role of the Flat Section 13f2 of the Barb Part 13f in the Resin Clip 13

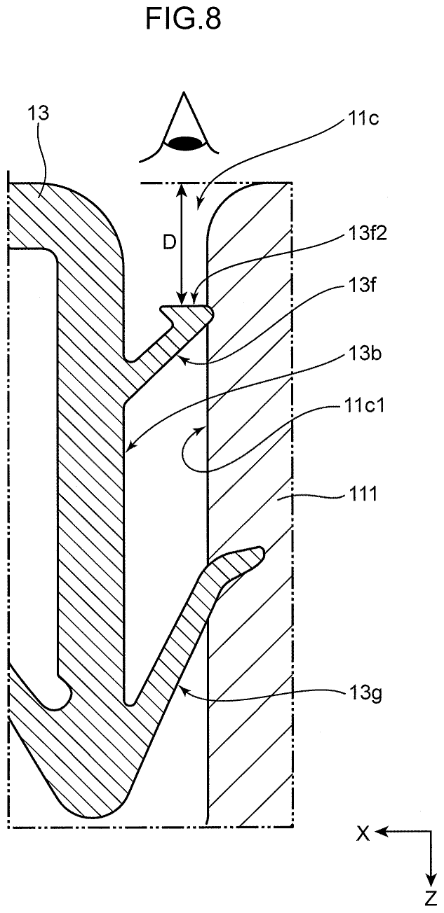

The barb part 13f of the resin clip 13 has the flat section 13f2. The role of the flat section 13f2 will be described with reference to FIG. 8.

As illustrated in FIG. 8, a part of the flat section 13f2 of the barb part 13f is exposed to the inside of the groove section 11c with respect to the side wall 11cl of the groove section 11c while the base 13b and other components of the resin clip 13 are in the groove section 11c. The flat section 13f2 faces the opening of the groove section 11c without any member to be an obstacle above the flat section 13f2. Hence, an operator can visually recognize the flat section 13f2 when seeing the inside of the groove section 11c with the eyes thereof through the opening of the groove section 11c. The operator then can visually confirm with the eyes thereof whether the resin clip 13 is at an appropriate position in the groove section 11c by checking a distance D from the opening of the groove section 11c to the flat section 13f2.

### 7. Detachment of the Resin Clip 13

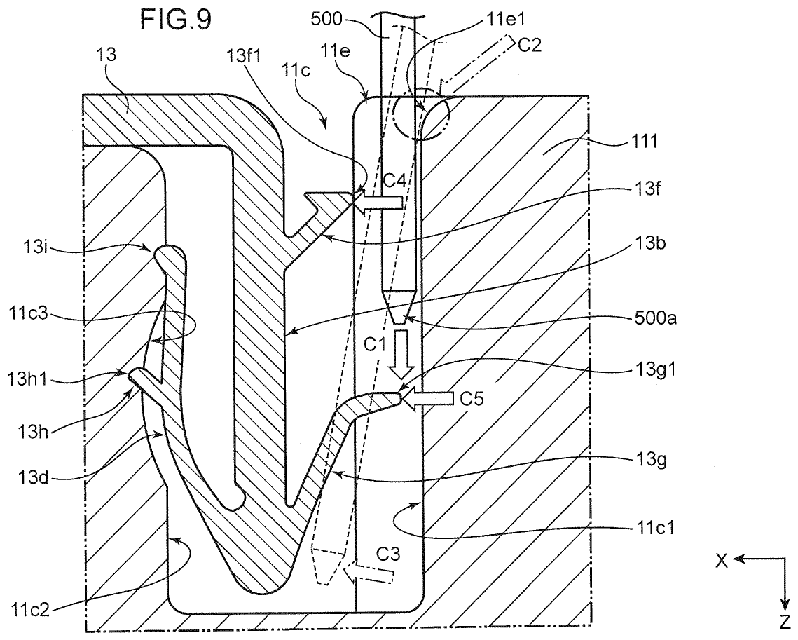

Regarding the seat 1, an end user may replace the trim 12 with another one. In such replacement of the trim 12, it is required to detach the resin clip 13 from the cushion pad 11. A way of detaching the resin clip 13 from the cushion pad 11 will be described with reference to FIG. 9.

As described with reference to FIG. 3, the cushion pad 11 has the communicating passage 11e that communicates with the groove section 11c. As illustrated in FIG. 9, a rod-shaped tool (e.g., a flathead screwdriver) is inserted in the communicating passage 11e from a leading end 500a thereof to detach the resin clip 13 from the cushion pad 11 (arrow C1).

When the leading end 500a of the tool 500 reaches a position around the bottom of the communicating passage 11e, the tool 500 is moved round about an opening edge 11e1 of the communicating passage 11e as a fulcrum as denoted by an arrow C2 so that the leading end 500a moves toward the side wall 11c2 (arrow C3).

The tool 500 having been moved around in the aforementioned manner results in pulling the respective leading ends 13f1, 13g1 of the barb parts 13f, 13g, which are stuck in the hard pad 111 from the side wall 11c1, out of the hard pad 111 (arrows C4, C5). The resin clip 13 is then taken out from the groove section 11c together with the tool 500 by shifting the base 13b of the resin clip 13 rightward in the X-direction while keeping the barb parts 13f, 13g of the resin clip 13 elastically deformed.

Consequently, the detachment of the resin clip is completed.

### 8. Effects

The structure of fixing the trim 12 to the cushion pad 11 with the resin clip 13 through the groove section 11c of the cushion pad 11 always keeps the trim fixing part 13a of the resin clip 13 under tension applied leftward in the X-direction in FIG. 7 and other drawings. The resin clip 13 under the tension receives a directional rotation moment aimed at moving the bottom end 13c of the base 13b rightward in the X-direction in FIG. 7 and other drawings. If the resin clip 13 has heat while receiving the moment, the resin clip 13 is likely to soften and plastically deform, the resin clip 13 has a tendency to soften and plastically deform, and may come off the groove section 11c.

In this regard, in the seat 1 according to the embodiment, the resin clip 13 has the three barb parts 13f to 13h, and the respective leading ends 13f1, 13g1, 13h1 of the barb parts 13f to 13h are stuck in the hard pad 111 of the cushion pad 11. Hence, even when the resin clip 13 has heat, the barb parts 13f to 13h prevent the resin clip 13 from coming off.

When the resin clip 13 receives the rotation moment denoted by the arrow B2 in FIG. 7, the respective leading ends 13f1, 13g1 of the barb parts 13f, 13g are further deeply stuck in the hard pad 111 of the cushion pad 11. This is advantageous to effectively prevent the resin clip 13 from coming off.

The resin clip 13 has the barb part 13h being continuous to an intermediate portion of the curving part 13d in a longitudinal direction thereof, and thus maintains the state where the force acts such that the leading end 13h1 of the barb part 13h is further deeply stuck in the hard pad 111 of the cushion pad 11 leftward in the X-direction with the reaction force. Accordingly, the base 13b of the resin clip 13 keeps a stable posture in the groove section 11c of the cushion pad 11, and the base 13b and the curving part 13d are unlikely to rattle in the groove section 11c.

In the seat 1 according to the embodiment, the leading end 13g1 of the barb part 13g and the leading end 13h1 of the barb part 13h in the resin clip 13 are defined to be at the same height position in a depth direction of the groove section 11c. This is advantageous to keep the posture of the base 13b, that is, to keep an appropriate posture of the resin clip 13, in the groove section 11c.

In the seat 1 according to the embodiment, the respective leading ends 13f1, 13g1, 13h1 of the barb parts 13f to 13h in the resin clip 13 face the lower surface 11b formed with the opening of the groove section 11c in the cushion pad 11. When the resin clip 13 receives a force aimed at making the resin clip come off the groove section 11c, the respective leading ends 13f1, 13g1, 13h1 of the barb parts 13f to 13h are further deeply stuck in the cushion pad 11. This is further advantageous in the seat 1 to prevent the resin clip 13 from coming off the groove section 11c of the cushion pad 11.

In the seat 1 according to the embodiment, the cushion pad 11 further has the communicating passage 11e. This allows the tool (e.g., a rod-shaped tool, such as a flathead screwdriver) 500 to be inserted in the communicating passage 11e to release the state of the respective leading ends 13f1, 13g1 of the barb parts 13f, 13g stuck in the cushion pad 11, and thereby detach the resin clip 13 from the groove section 11c. For instance, in a case where an end user replaces the trim 12 with another one, the configuration prevents a periphery of the groove section 11c of the cushion pad 11 from peeling off.

Here, in the seat 1 according to the embodiment, each of the respective leading ends 13f1, 13g1, 13h1 of the barb parts 13f to 13h in the resin clip 13 tapers. As illustrated in FIG. 7 and other drawings, each of the leading ends 13f1, 13g1, 13h1 has a round tip (with a curving surface). The configuration thus ensures facilitated pulling performance of detaching the resin clip 13 from the groove section 11c with the tool 500. In the detachment of the resin clip 13 from the groove section 11c, the configuration prevents the side walls 11c1, 11c2 on the periphery of the groove section 11c from peeling off, and attains replacement of the trim 12 with another one to extend over the cushion pad 11 while ensuring high maintainability.

In a configuration where each of the respective leading ends 13f1, 13g1, 13h1 of the barb parts 13f to 13h in the resin clip 13 is sharp, the resin clip 13 is unlikely to come off the groove section 11c even when the resin clip 13 receives the rotation moment illustrated in FIG. 7 under the tension from the trim 12.

In the seat 1 according to the embodiment, at least the groove section 11c and a periphery of the groove section 11c in the cushion pad 11 include the hard pad 111 made of beads foam. Thus, the respective leading ends 13f1, 13g1, 13h1 of the barb parts 13f to 13h of the resin clip 13 are reliably stuck in the cushion pad 11.

The seat 1 according to the embodiment adopts the hard pad 111 made of beads foam having low resilience. This allows each of the leading ends 13f1, 13g1, 13h1 of the barb parts 13f to 13h to be reliably stuck in the hard pad 111 even with a round tip as illustrated in FIG. 6 and FIG. 7.

In the seat 1 according to the embodiment, the barb part 13f has the flat section 13f2 that is adjacent to the leading end 13f1. This allows an operator to insert the resin clip 13 in the groove section 11c and confirm that the resin clip 13 reaches an appropriate depth depending on the location of the flat section 13f2 in the depth direction of the groove section 11c. The seat 1 thus avoids insertion of the resin clip 13 in the groove section 11c in an unstable state, and further effectively prevents the resin clip 13 from coming off the groove section 11c.

In the seat 1 according to the embodiment, the curving part 13d of the resin clip 13 has the leading end 13i facing the side wall 11c2, and tapers from the vicinity of the leading end 13i toward the leading end 13i, so that the leading end 13i is slightly pushed in the hard pad 111 of the cushion pad 11 from the side wall 11c2. This prevents the resin clip 13 in the groove section 11c from rattling in the groove section 11c, and keeps a stable posture of the resin clip 13.

Conclusively, the seat 1 according to the embodiment prevents the resin clip 13 from coming off the cushion pad 11 even when the resin clip 13 has heat and softens, and allows the trim 12 to maintain a state of being stably fixed to the cushion pad 11.

### Modifications

The leading end 13i of the curving part 13d of the resin clip 13 is pushed in the cushion pad 11 in the embodiment as an example. However, the present invention does not necessarily require a leading end of a curving part to be pushed in a cushion pad. For instance, the leading end of the curving part may be apart from a side wall of a groove section.

The cushion pad 11 further includes the communicating passage 11e in addition to the groove section 11c in the embodiment. However, the present invention does not necessarily require a communicating passage.

The cushion pad 11 includes the hard pad 111 made of beads foam in the embodiment. However, the present invention does not necessarily require a hard pad made of beads foam. Besides, it is not indispensable for a cushion pad to have a layered structure including a soft pad and a hard pad in a stacked manner. For instance, such a cushion pad having a single-layered structure or a cushion pad having a three or more-layered structure may be adopted.

The barb part 13f of the resin clip 13 has the flat section 13f2 in the embodiment. However, in the present invention, the barb part 13f does not necessarily have the flat section 13f2. A mark for confirming an insertion depth degree may be given to a base in place of the flat section 13f2 of the barb part 13f.

Although the resin clip 13 has the three barb parts 13f to 13h in the embodiment, the resin clip 13 may have four or more barb parts in the present invention.

### Conclusion

A seat according to one aspect of the present invention includes a cushion pad, a trim, and a resin clip. The cushion pad has a support region for supporting an occupant, and other region excluding the support region and having a groove section in a thickness direction. The trim has a covering region that covers the support region of the cushion pad and an end being adjacent to the groove section. The resin clip is made of resin material, holds the end of the trim, and is configured to fix the trim and the cushion pad to each other through the groove section.

In the seat according to the aspect, the resin clip has a base, a trim fixing part, a curving part, a first barb part, a second barb part, and a third barb part. The base is in or inserted into-the groove section of the cushion pad. The trim fixing part is continuous to a portion at an upper end of the base, extends from the continuous portion along a surface of the cushion pad in a first direction being in a width direction of the groove section, and fixes the end of the trim thereto. The curving part has one end being continuous to the base and other end being a free end, has a curve shape to be farther away from the base in the first direction as advancing from the one end toward the other end, is in or inserted into the groove section together with the base while extending along the base, and has flexibility.

The first barb part is continuous to a portion of the curving part between the one end and the other end, extends from the continuous portion in the first direction, and has a leading end which tapers. The second barb part is continuous to a portion of the base, extends from the continuous portion in a second direction opposite to the first direction being in the width direction of the groove section, and has a leading end which tapers. The third barb part is continuous to a portion of the base between the continuous portion to the second barb part and the continuous portion to the trim fixing part, extends from the portion in the second direction, and has a leading end which tapers.

In the seat according to the aspect, each of the base and the curving part of the resin clip is pressed with a pressing force in such a manner that the other end is closer to the base in a state where the base and the curving part are in the groove section than in a free state where the base and the curving part are outside the groove section.

In the seat according to the aspect, in the groove section of the cushion pad, the leading end of the first barb part is pushed in the cushion pad from a first side wall being a side wall of the groove section in the first direction with a reaction force against the pressing force. The leading end of the second barb part and the leading end of the third barb part are pushed in the cushion pad from a second side wall being a side wall of the groove section in the second direction with a reaction force against the pressing force.

As described above, a structure of fixing a trim to a cushion pad with a resin clip through a groove section always keeps trim fixing part under tension applied in the first direction. The resin clip under the tension receives a directional rotation moment aimed at moving a bottom end (or an end to be inserted in the depth of the groove section) of a base in the second direction. When the resin clip has heat in connection with the rotation moment, the resin clip may come off the groove section.

In contrast, in the seat in the aspect, the resin clip has the first to third barb parts, and the respective leading ends of the barb parts are stuck (pushed) in the cushion pad. Hence, even when the resin clip has heat, the barb parts prevent the resin clip from coming off.

When the resin clip receives the rotation moment, the respective leading ends of the second and third barb parts are further deeply stuck in the cushion pad. This is advantageous to effectively prevent the resin clip from coming off.

The resin clip has the first barb part being continuous to a portion of the curving part between the one end and the other end, and thus maintains the state where the force continuously acts such that the leading end of the first barb part is further deeply stuck in the cushion pad in the first direction with the reaction force against the pressing force. Accordingly, the base keeps a stable posture in the groove section, and the base and the curving part are unlikely to rattle in the groove section.

In the seat according to the aspect, the leading end of the first barb part and the leading end of the second barb part may be at a same height position in a depth direction of the groove section.

In the seat in the aspect, the leading end of the first barb part and the leading end of the second barb part in the resin clip are defined to be at the same height position in the depth direction of the groove section. This is advantageous to keep the posture of the base, that is, to keep an appropriate posture of the resin clip, in the groove section.

In the seat according to the aspect, the leading end of each of the first barb part, the second barb part, and the third barb part may face the surface of the cushion pad formed with an opening of the groove section.

In the seat in the aspect, the respective leading ends of the first to third barb parts in the resin clip face the surface formed with the opening of the groove section in the cushion pad. When the resin clip receives a force aimed at making the resin clip come off the groove section, the respective leading ends of the barb parts are further deeply stuck in the cushion pad. This is further advantageous in the seat to prevent the resin clip from coming off the groove section of the cushion pad.

In the seat according to the aspect, each of the groove section of the cushion pad and the resin clip may extend in a fourth direction perpendicularly intersecting the first direction and a third direction being an insertion direction of the base. The cushion pad may further have a communicating passage recessed inward from the second side wall to communicate with the groove section in a region ranging from a part of the groove section in the fourth direction to a location of the second barb part in the third direction.

In the seat in the aspect, the cushion pad further has the communicating passage. This allows a tool (e.g., a rod-shaped tool, such as a flathead screwdriver) to be inserted in the communicating passage to release the state of the second barb part and the third barb part stuck in the cushion pad, and thereby detach the resin clip from the groove section. For instance, in a case where an end user replaces the trim with another one, this configuration prevents the periphery of the groove section of the cushion pad from peeling off.

In the seat according to the aspect, the cushion pad may have a portion made of beads foam. The groove section and a periphery of the groove section may be located at the portion made of beads foam.

In the seat in the aspect, at least the groove section and the periphery of the groove section in the cushion pad include the portion made of beads foam. Thus, the respective leading ends of the barb parts of the resin clip are reliably stuck in the cushion pad.

In the seat according to the aspect, the third barb part may have a flat section that is adjacent to the leading end in a direction perpendicularly intersecting the depth direction of the groove section and that faces the opening of the groove section.

In the seat in the aspect, the third barb part has the flat section that is adjacent to the leading end of the third barb part. This allows an operator to insert the resin clip in the groove section and confirm that the resin clip reaches an appropriate depth depending on the location of the flat section in the depth direction of the groove section. The seat having this configuration thus avoids insertion of the resin clip in the groove section in an unstable state, and further effectively prevents the resin clip from coming off the groove section.

In the seat according to the aspect, the other end of the curving part may face in the first direction, and the curving part may taper from a vicinity of the other end toward the other end. The other end of the curving part may be pushed in the cushion pad from the first side wall.

In the seat in the aspect, the curving part of the resin clip tapers from the vicinity of the other end toward the other end in such a manner that the other end is pushed in the cushion pad from the first side wall. This prevents the resin clip in the groove section from rattling in the groove section, and keeps a stable posture of the resin clip.

Conclusively, the seat in each aspect prevents the resin clip from coming off the cushion pad and allows the trim to maintain a state of being stably fixed to the cushion pad even when the resin clip has heat.

1. A seat, comprising:
a cushion pad having a support region for supporting an occupant, and other region excluding the support region and having a groove section in a thickness direction;
a trim having a covering region that covers the support region of the cushion pad, and an end being adjacent to the groove section; and
a resin clip made of resin material, holding the end of the trim, and configured to fix the trim and the cushion pad to each other through the groove section, wherein
the resin clip has:
a base being in the groove section of the cushion pad;
a trim fixing part being continuous to a portion at an upper end of the base, extending from the continuous portion along a surface of the cushion pad in a first direction being in a width direction of the groove section, and fixing the end of the trim thereto;
a curving part having one end being continuous to the base and other end being a free end, having a curve shape to be farther away from the base in the first direction as advancing from the one end toward the other end, being in the groove section together with the base while extending along the base, and having flexibility;
a first barb part being continuous to a portion of the curving part between the one end and the other end, extending from the continuous portion in the first direction, and having a leading end which tapers;
a second barb part being continuous to a portion of the base, extending from the continuous portion in a second direction opposite to the first direction being in the width direction of the groove section, and having a leading end which tapers; and
a third barb part being continuous to a portion of the base between the continuous portion to the second barb part and the continuous portion to the trim fixing part, extending from the portion in the second direction, and having a leading end which tapers,
each of the base and the curving part of the resin clip is pressed with a pressing force in such a manner that the other end is closer to the base in a state where the base and the curving part are in the groove section than in a free state where the base and the curving part are outside the groove section, and,
in the groove section of the cushion pad,
the leading end of the first barb part is pushed in the cushion pad from a first side wall being a side wall of the groove section in the first direction with a reaction force against the pressing force, and
the leading end of the second barb part and the leading end of the third barb part are pushed in the cushion pad from a second side wall being a side wall of the groove section in the second direction with a reaction force against the pressing force.

2. The seat according to claim 1, wherein the leading end of the first barb part and the leading end of the second barb part are at a same height position in a depth direction of the groove section.

3. The seat according to claim 1, wherein the leading end of each of the first barb part, the second barb part, and the third barb part faces the surface of the cushion pad formed with an opening of the groove section.

4. The seat according to claim 1, wherein each of the groove section of the cushion pad and the resin clip extends in a fourth direction perpendicularly intersecting the first direction and a third direction being an insertion direction of the base, and
the cushion pad further has a communicating passage recessed inward from the second side wall to communicate with the groove section in a region ranging from a part of the groove section in the fourth direction to a location of the second barb part in the third direction.

5. The seat according to claim 1, wherein the cushion pad has a portion made of beads foam, and
the groove section and a periphery of the groove section are located at the portion made of beads foam.

6. The seat according to claim 1, wherein the third barb part has a flat section that is adjacent to the leading end in a direction perpendicularly intersecting the depth direction of the groove section and that faces the opening of the groove section.

7. The seat according to claim 1, wherein the other end of the curving part faces in the first direction, and the curving part tapers from a vicinity of the other end toward the other end, and
the other end of the curving part is pushed in the cushion pad from the first side wall.
